(19) United States
(12) Patent Application Publication
(10) Pub. No.: US 2024/0193221 A1
(43) Pub. Date: Jun. 13, 2024

(54) INFORMATION PROCESSING APPARATUS, INFORMATION PROCESSING METHOD, AND COMPUTER-READABLE NON-TRANSITORY STORAGE MEDIUM

(71) Applicant: NEC Corporation, Tokyo (JP)

(72) Inventors: Dai KUBOTA, Tokyo (JP); Riki Eto, Tokyo (JP); Takahiro Nishimura, Tokyo (JP)

(73) Assignee: NEC Corporation, Tokyo (JP)

(21) Appl. No.: 18/385,636

(22) Filed: Oct. 31, 2023

(30) Foreign Application Priority Data
Dec. 9, 2022 (JP) 2022-197446

(51) Int. Cl. G06F 17/11

(52) U.S. Cl. CPC G06F 17/11

(57) ABSTRACT

At least one processor included in an information processing apparatus carries out: a first calculation process of calculating a solution of an optimization problem under a constraint condition which has been set in advance; and a second calculation process of calculating a robustness index of the solution with respect to the constraint condition based on the solution and the constraint condition. This makes it possible to support decision making of a user.

This Nonprovisional application claims priority under 35 U.S.C. § 119 on Patent Application No. 2022-197446 filed in Japan on Dec. 9, 2022, the entire contents of which are hereby incorporated by reference.

### TECHNICAL FIELD

The present invention relates to an information processing apparatus, an information processing method, and a computer-readable non-transitory storage medium for calculation of an index related to an optimization problem.

### BACKGROUND ART

Various optimization techniques are known for a mathematical model that represents an optimization problem in which an objective function to be optimized is minimized or maximized under a constraint condition that defines a search range of an optimum solution.

Patent Literature 1 discloses an optimization process apparatus that generates a prediction model for predicting, from training data, an evaluation value of a combination, and uses the prediction model to search for an optimum solution. In this case, the optimization process apparatus searches for the optimum solution within a range constricted by a distance.

### CITATION LIST

### Patent Literature

[Patent Literature 1]

Japanese Patent Application Publication, Tokukai, No. 2021-157456

### SUMMARY OF INVENTION

### Technical Problem

In order to correct an optimization problem, a technique for analyzing a solution is demanded. In particular, as information for analyzing a general solution to a general optimization problem, presentation of an index other than a value of an objective function for a solution and a value of the solution is demanded. However, Patent Literature 1 does not disclose a configuration corresponding to a configuration that presents an index other than a value of an objective function for a solution and a value of the solution.

An example aspect of the present invention is accomplished in view of the above problem, and an example object thereof is to provide a technique for providing an index that is necessary for correction of an optimization problem.

### Solution to Problem

An information processing apparatus in accordance with an example aspect of the present invention includes at least one processor, the at least one processor carrying out: a first calculation process of calculating a solution of an optimization problem under a constraint condition which has been set in advance; and a second calculation process of calculating a robustness index of the solution with respect to the constraint condition based on the solution and the constraint condition.

An information processing method in accordance with an example aspect of the present invention includes: calculating, by at least one processor, a solution of an optimization problem under a constraint condition which has been set in advance; and calculating, by the at least one processor, a robustness index of the solution with respect to the constraint condition based on the solution and the constraint condition.

A computer-readable non-transitory storage medium in accordance with an example aspect of the present invention stores a program for causing a computer to function as an information processing apparatus, the program causing the computer to carry out: a first calculation process of calculating a solution of an optimization problem under a constraint condition which has been set in advance; and a second calculation process of calculating a robustness index of the solution with respect to the constraint condition based on the solution and the constraint condition.

### Advantageous Effects of Invention

According to an example aspect of the present invention, it is possible to provide an index that is necessary for correction of an optimization problem.

### BRIEF DESCRIPTION OF DRAWINGS

FIG. 1 is a block diagram illustrating a configuration of an information processing apparatus in accordance with a first example reference embodiment of the present invention.

FIG. 2 is a flowchart illustrating a flow of an information processing method in accordance with the first example reference embodiment of the present invention.

FIG. 3 is a block diagram illustrating a configuration of an information processing apparatus in accordance with a second example reference embodiment of the present invention.

FIG. 4 is a flowchart illustrating a flow of an information processing method in accordance with the second example reference embodiment of the present invention.

FIG. 5 is a flowchart illustrating a flow of a process of calculating a progress level in the second example reference embodiment of the present invention.

FIG. 6 is a flowchart illustrating a flow of a process of calculating a progress level in the second example reference embodiment of the present invention.

FIG. 7 is a block diagram illustrating a configuration of an information processing apparatus in accordance with a first example embodiment of the present invention.

FIG. 8 is a flowchart illustrating a flow of an information processing method in accordance with the first example embodiment of the present invention.

FIG. 9 is a block diagram illustrating a configuration of an information processing apparatus in accordance with a second example embodiment of the present invention.

FIG. 10 is a flowchart illustrating a flow of an information processing method in accordance with the second example embodiment of the present invention.

FIG. 11 is a block diagram illustrating a configuration of a computer that functions as the information processing apparatus in accordance with each of the example embodiments or the information processing apparatus in accordance with each of the example reference embodiments.

FIG. 12 illustrates an example of a table in an example application of the present invention.

### EXAMPLE EMBODIMENTS

### [Optimization Problem]

An information processing apparatus in accordance with each of example embodiments and each of example reference embodiments described below is an apparatus that calculates an index that is necessary for correction of an optimization problem. An optimization problem to be dealt with is not particularly limited, and is assumed to be, for example, the following optimization problem.

### (Optimization Problem)

A problem of finding an element (x₁, x₂, . . . , xᵣ)□X that maximizes an objective function f (x₁, x₂, . . . , xᵣ) in a solution space X is referred to as an “optimization problem”. Here, the solution space X is a set of elements (x₁, x₂, . . . , xᵣ) that satisfy constraint conditions C1, C2, . . . , Cm. Each of constraint conditions Ci (i=1, 2, . . . , m) is expressed by a mathematical formula (e.g., an equality or an inequality) that includes some or all of the variables x₁, x₂, . . . , xᵣ.

### (Linear Programming Problem, Integer Linear Programming Problem, Mixed Integer Linear Programming Problem)

Among optimization problems in which an objective function and a constraint condition become linear with respect to all variables, an optimization problem in which variables x₁, x₂, . . . , xᵣ are continuous variables (real number variables) is referred to as a “linear programming problem”, and an optimization problem in which variables x₁, x₂, . . . , xᵣ are discrete variables (integer variables) is referred to as an “integer linear programming problem”. Among optimization problems in which an objective function and a constraint condition become linear with respect to all variables, an optimization problem in which both a continuous variable and a discrete variable are included in variables x₁, x₂, . . . , xᵣ is referred to as a “mixed integer linear programming problem”. An optimization problem in which variables x₁, x₂, . . . , xᵣ are continuous variables (real number variables), and an objective function f (x₁, x₂, . . . , xᵣ) and a constraint condition are quadratic with respect to x is referred to as a “quadratic programming problem”.

### (Quadratic Unconstrained Binary Optimization Problem)

A problem of finding an element (x₁, x₂, . . . , xᵣ)□X that maximizes an objective function f (x₁, x₂, . . . , xᵣ) below is referred to as a “quadratic unconstrained binary optimization problem”. Here, the variables x₁, x₂, . . . , xᵣ are binary variables each taking a value of 0 or 1. In the quadratic unconstrained binary optimization problem, a constraint condition cannot be directly dealt with. However, it is possible to approximately deal with a constraint condition by adding a term corresponding to the constraint condition to an objective function.

$$\\ f ( {x}_{1} , {x}_{2} , … , {x}_{Γ} ) = {\sum }_{γ \neq δ} {Q}_{γ δ} {x}_{γ} {x}_{δ}$$

### First Example Reference Embodiment

The following description will discuss a first example reference embodiment of the present invention in detail, with reference to the drawings. The present example reference embodiment is a basic form of example reference embodiments described later.

### (Configuration of Information Processing Apparatus 1)

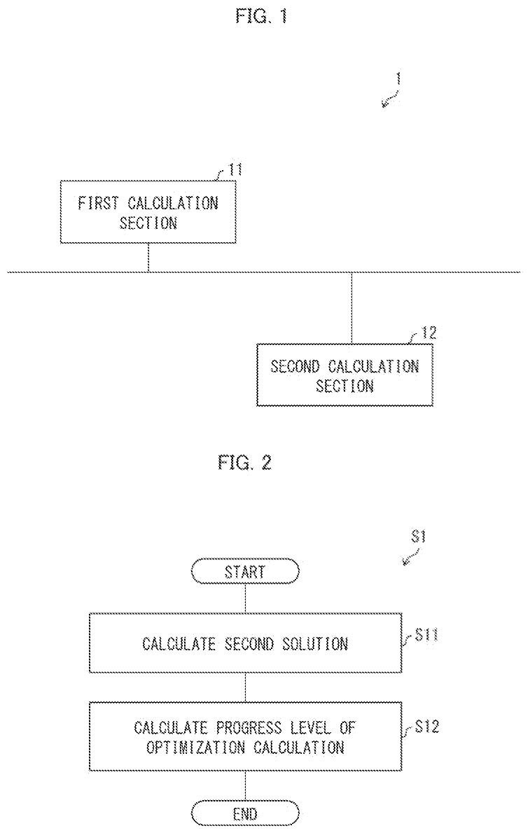

The following description will discuss a configuration of an information processing apparatus 1 in accordance with the present example reference embodiment, with reference to FIG. 1. FIG. 1 is a block diagram illustrating the configuration of the information processing apparatus 1 in accordance with the present example reference embodiment.

The information processing apparatus 1 in accordance with the present example reference embodiment is an apparatus that calculates a progress level of optimization calculation by referring to a first solution of an optimization problem as well as a second solution that converges to the first solution under a constraint condition that has been set in advance.

Here, the progress level is an index that indicates a degree to which optimization calculation has progressed. A specific calculation method will be described later.

The “first solution” includes a global optimum solution of an optimization problem and an approximate solution thereof under the constraint condition that has been set in advance. The “second solution” includes an intermediate solution that converges to the global optimum solution or the approximate solution thereof.

The information processing apparatus 1 in accordance with the present example reference embodiment includes, as illustrated in FIG. 1, a first calculation section 11 and a second calculation section 12.

The first calculation section 11 calculates a second solution that converges to a first solution of an optimization problem under a constraint condition that has been set in advance. The first calculation section 11 supplies the calculated second solution to the second calculation section 12.

The second calculation section 12 calculates, by referring to the first solution as well as the second solution calculated by the first calculation section 11, a progress level of optimization calculation by the first calculation section 11.

As described above, the information processing apparatus 1 in accordance with the present example reference embodiment employs the configuration of including: the first calculation section 11 that calculates a second solution which converges to a first solution of an optimization problem under a constraint condition that has been set in advance; and the second calculation section 12 that calculates, by referring to the first solution as well as the second solution calculated by the first calculation section 11, a progress level of optimization calculation by the first calculation section 11.

As such, even in a case where optimization calculation has not been carried out to the end and a user has confirmed a calculation result midway through the optimization calculation when a mathematical model representing an optimization problem is corrected, the information processing apparatus 1 in accordance with the present example reference embodiment makes it possible to provide a progress level that indicates a degree to which optimization calculation has progressed. The user can determine, with reference to the progress level, whether or not to carry out optimization calculation again. Therefore, according to the information processing apparatus 1 in accordance with the present example reference embodiment, it is possible to bring about an example advantage of providing an index that is necessary for correction of an optimization problem.

### (Flow of Information Processing Method S1)

The following description will discuss a flow of an information processing method S1 in accordance with the present example reference embodiment, with reference to FIG. 2. FIG. 2 is a flowchart illustrating the flow of the information processing method S1 in accordance with the present example reference embodiment.

### (Step S11)

In step S11, the first calculation section 11 calculates a second solution that converges to a first solution of an optimization problem under a constraint condition that has been set in advance. The first calculation section 11 supplies the calculated second solution to the second calculation section 12.

### (Step S12)

In step S12, the second calculation section 12 calculates, by referring to the first solution as well as the second solution calculated by the first calculation section 11, a progress level of optimization calculation by the first calculation section 11.

As described above, the information processing method S1 in accordance with the present example reference embodiment employs the configuration of including: step S11 in which the first calculation section 11 calculates a second solution which converges to a first solution of an optimization problem under a constraint condition that has been set in advance; and step S12 in which the second calculation section 12 calculates, by referring to the first solution as well as the second solution calculated by the first calculation section 11, a progress level of optimization calculation by the first calculation section 11. Therefore, according to the information processing method S1 of the present example reference embodiment, an example advantage similar to that of the foregoing information processing apparatus 1 is brought about.

### Second Example Reference Embodiment

The following description will discuss a second example reference embodiment of the present invention in detail, with reference to the drawings. The same reference numerals are given to constituent elements which have functions identical with those described in the first example reference embodiment, and descriptions as to such constituent elements are omitted as appropriate.

### (Overview of Information Processing Apparatus 3)

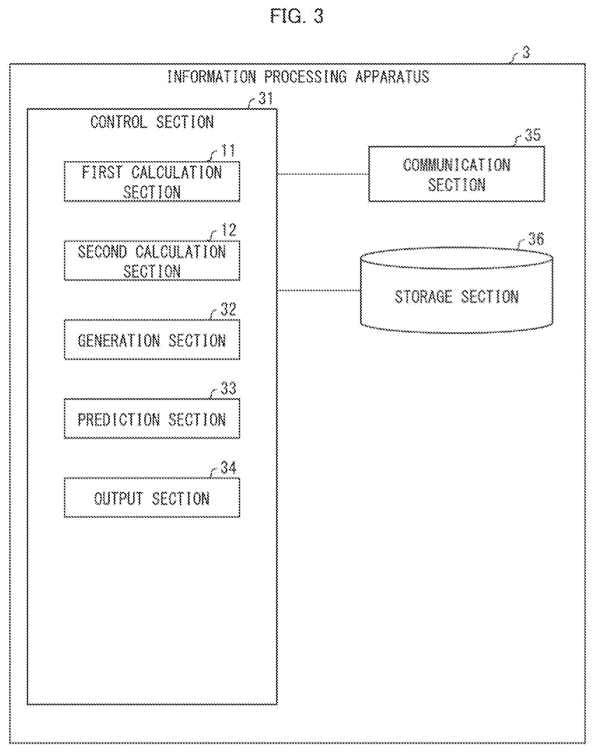

The following description will discuss a configuration of an information processing apparatus 3 in accordance with the present example reference embodiment, with reference to FIG. 3. FIG. 3 is a block diagram illustrating the configuration of the information processing apparatus 3 in accordance with the present example reference embodiment.

The information processing apparatus 3 in accordance with the present example reference embodiment is an apparatus that calculates a progress level of optimization calculation by referring to a first solution of an optimization problem as well as a second solution that converges to the first solution under a constraint condition that has been set in advance.

Examples of the “progress level” include a distance between an intermediate solution x and a global optimum solution xₒₚₜ or an approximate solution x_{LP}, and a search rate r that indicates a proportion of a region in which search for a solution has been completed in a solution space of an optimization problem.

The “first solution” includes a global optimum solution xₒₚₜ of an optimization problem and an approximate solution x_{LP} thereof under the constraint condition that has been set in advance. The “second solution” includes an intermediate solution x that converges to the global optimum solution xₒₚₜ or the approximate solution x_{LP} thereof. In other words, the information processing apparatus 3 is an apparatus that calculates a progress level of optimization calculation by referring to a global optimum solution xₒₚₜ of an optimization problem or an approximate solution x_{LP} thereof as well as an intermediate solution x that converges to the global optimum solution xₒₚₜ or the approximate solution x_{LP} thereof under a constraint condition that has been set in advance.

### (Configuration of Information Processing Apparatus 3)

The information processing apparatus 3 in accordance with the present example reference embodiment includes, as illustrated in FIG. 3, a control section 31, a communication section 35, and a storage section 36.

The communication section 35 is an interface that transmits and receives data. Examples of data received by the communication section 35 include a variable to be optimized, an objective function, a constraint condition, and a global optimum solution xₒₚₜ. Examples of data transmitted by the communication section 35 include a progress level of an intermediate solution x.

The information processing apparatus 3 may be configured to include, instead of or in addition to the communication section 35, a data input section which is an interface for receiving data input, and a data output section which is an interface for outputting data.

The storage section 36 stores data which the control section 31 refers to. Examples of data stored in the storage section 36 include a variable to be optimized, an objective function, a constraint condition, an intermediate solution x, an optimum solution for a relaxation problem (described later), and a global optimum solution xₒₚₜ.

### (Function of Control Section 31)

The control section 31 controls constituent elements included in the information processing apparatus 3. The control section 31 includes a first calculation section 11, a second calculation section 12, a generation section 32, a prediction section 33, and an output section 34.

The first calculation section 11 calculates an intermediate solution x that converges to a global optimum solution xₒₚₜ of an optimization problem or an approximate solution x_{LP} thereof under a constraint condition that has been set in advance. For example, the first calculation section 11 (i) acquires a variable to be optimized, an objective function, and a constraint condition that are stored in the storage section 36 and (ii) calculates an intermediate solution x that converges, under the constraint condition, to a global optimum solution xₒₚₜ of an optimization problem that maximizes or minimizes the objective function or an approximate solution x_{LP} thereof. The first calculation section 11 causes the storage section 36 to store the calculated intermediate solution x. Examples of a method in which the first calculation section 11 calculates an intermediate solution x include a method in which a result which has been confirmed midway through calculation prior to the calculation of a global optimum solution xₒₚₜ or an approximate solution x_{LP} thereof is calculated as an intermediate solution x.

The second calculation section 12 refers to the global optimum solution xₒₚₜ or the approximate solution x_{LP} thereof as well as the intermediate solution x calculated by the first calculation section 11, and thus the second calculation section 12 calculates a progress level of optimization calculation by the first calculation section 11. For example, the second calculation section 12 acquires an intermediate solution x that is stored in the storage section 36. In a case where a global optimum solution xₒₚₜ is stored in the storage section 36, the second calculation section 12 acquires the global optimum solution xₒₚₜ as well. Moreover, the second calculation section 12 acquires an optimum solution of a relaxation problem that has been generated by the generation section 32 (described later). Then, the second calculation section 12 refers to the global optimum solution xₒₚₜ or an optimum solution of the relaxation problem as an approximate solution x_{LP}, as well as the acquired intermediate solution x, and thus calculates a progress level. An example of a process in which the second calculation section 12 calculates a progress level will be described later.

The generation section 32 generates a relaxation problem in which a variable to be optimized in an optimization problem is a continuous variable. Examples of a method in which the generation section 32 generates a relaxation problem include a method in which, in a case where variables to be optimized (for example, variables of an objective function) in an optimization problem include a discrete variable(s) (for example, an integer(s)), a relaxation problem is generated by replacing the discrete variable(s) with a continuous variable(s).

The prediction section 33 predicts a remaining time of an optimization problem. For example, the prediction section 33 predicts a remaining time of an optimization problem by inputting a progress level calculated by the second calculation section 12 into a prediction model which has been generated by machine learning.

Here, the prediction model is information that represents a relationship between an explanatory variable and an objective variable. The prediction model is, for example, a component for estimating a result of an estimation target by calculating an objective variable based on an explanatory variable. The prediction model may be referred to as a “learning model”, an “analysis model”, an “AI model”, a “learned model”, an “inference model”, or a “prediction expression”.

A training algorithm for generating the prediction model is not particularly limited, and may be an existing training algorithm. For example, the training algorithm can be a random forest, a support vector machine, Naive Bayes, or a neural network.

As another example, the prediction section 33 predicts a remaining time of an optimization problem by inputting a progress level calculated by the second calculation section 12 into a rule-based algorithm.

The output section 34 outputs data via the communication section 35. For example, the output section 34 outputs a progress level calculated by the second calculation section 12. The output section 34 may output a remaining time predicted by the prediction section 33.

The output section 34 may output the calculated progress level (and the predicted remaining time) as an image via a display or as audio via a speaker. The output section 34, in the case of output as an image, may output the image so as to display a bar graph or a circle graph according to the calculated progress level. In a case where a search rate r is calculated as the progress level, the output section 34 may display the search rate r as a percentage by using a circle graph or the like.

### (Flow of Information Processing Method S3)

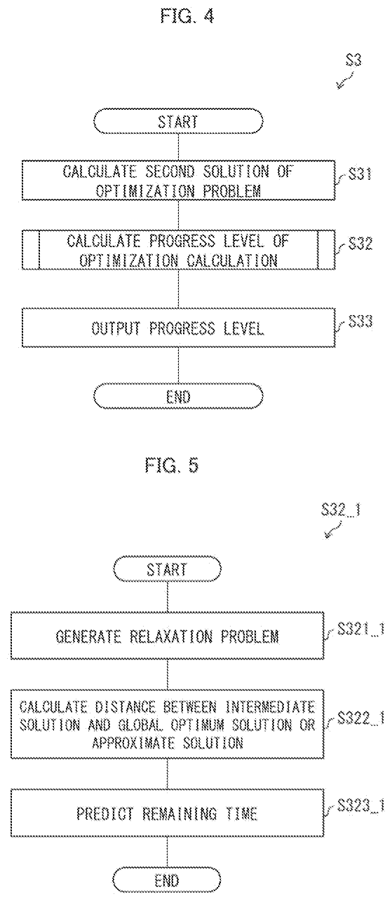

The following description will discuss a flow of a process in which the information processing apparatus 3 outputs a progress level, with reference to FIG. 4. FIG. 4 is a flowchart illustrating the flow of the information processing method S3 in accordance with the present example reference embodiment.

### (Step S31)

In step S31, the first calculation section 11 (i) acquires a variable to be optimized, an objective function, and a constraint condition from the storage section 36 and (ii) calculates a second solution (intermediate solution x) that converges, under the constraint condition, to a first solution (global optimum solution xₒₚₜ or approximate solution x_{LP} thereof) of an optimization problem that maximizes or minimizes the objective function. The first calculation section 11 causes the storage section 36 to store the calculated intermediate solution x.

### (Step S32)

In step S32, the second calculation section 12 refers to the global optimum solution xₒₚₜ or the approximate solution x_{LP} thereof as well as the intermediate solution x calculated by the first calculation section 11, and thus the second calculation section 12 calculates a progress level of optimization calculation by the first calculation section 11. The second calculation section 12 causes the storage section 36 to store the calculated progress level. An example of a process in which the second calculation section 12 calculates a progress level will be described later.

### (Step S33)

In step S33, the output section 34 outputs, via the communication section 35, the progress level stored in the storage section 36.

### (Example 1 of Process of Calculating Progress Level)

The following description will discuss an example of the process of the foregoing step S32, with reference to FIG. 5. FIG. 5 is a flowchart illustrating a flow of a process S32_1 of calculating a progress level in the present example reference embodiment. With reference to FIG. 5, a process will be described in which the second calculation section 12 calculates, as a progress level, a distance between an intermediate solution x and a global optimum solution xₒₚₜ or an approximate solution x_{LP}.

### (Step S321_1)

In step S321_1, the generation section 32 generates a relaxation problem in which a variable to be optimized in an optimization problem is a continuous variable. The method in which the generation section 32 generates a relaxation problem is as described above. The generation section 32 causes the storage section 36 to store the generated relaxation problem.

### (Step S322_1)

In step S322_1, the second calculation section 12 calculates, as a progress level, a distance between an intermediate solution x and a global optimum solution xₒₚₜ or an approximate solution x_{LP}. An example of step S322_1 will be described below.

The second calculation section 12 first acquires a relaxation problem from the storage section 36. Then, the second calculation section 12 calculates an optimum solution (i.e., an approximate solution x_{LP} of a global optimum solution xₒₚₜ) of the relaxation problem.

In a case where the second calculation section 12 has been able to acquire a global optimum solution xₒₚₜ from the storage section 36, the second calculation section 12 calculates a distance between an intermediate solution x and the global optimum solution xₒₚₜ. For example, the second calculation section 12 calculates a distance between the intermediate solution x and the global optimum solution xₒₚₜ using the following formula (1).

f(xₒₚₜ,x)=|xₒₚₜ−x| (1)

Meanwhile, in a case where the second calculation section 12 has not been able to acquire a global optimum solution xₒₚₜ from the storage section 36, the second calculation section 12 may calculate a distance between an intermediate solution x and an approximate solution x_{LP}. For example, the second calculation section 12 calculates a distance between the intermediate solution x and the approximate solution x_{LP} using the following formula (2).

f(x_{LP},x)=|x_{LP}−x| (2)

The second calculation section 12 causes the storage section 36 to store the calculated distance.

The second calculation section 12 may calculate a distance using a learned model. For example, it is possible to employ a configuration in which the second calculation section 12 uses a learned model that uses an intermediate solution x and a global optimum solution xₒₚₜ or an approximate solution x_{LP} as input and that outputs a distance between the intermediate solution x and the global optimum solution xₒₚₜ or a distance between the intermediate solution x and the approximate solution x_{LP}.

Thus, the second calculation section 12 calculates, as a progress level of optimization calculation, a distance between the intermediate solution x and the global optimum solution xₒₚₜ or the approximate solution x_{LP}. Therefore, the second calculation section 12 can provide, as an index that is necessary for correction of an optimization problem, a distance between an intermediate solution x and a global optimum solution xₒₚₜ or an approximate solution x_{LP}.

The second calculation section 12 calculates a distance between an intermediate solution x and an approximate solution x_{LP} while regarding an optimum solution of a relaxation problem as the approximate solution x_{LP}. The optimum solution of the relaxation problem can be optimization-calculated at a higher speed as compared with a problem in which a discrete variable exists. Therefore, the second calculation section 12 makes it possible to reduce a calculation time.

### (Step S323_1)

In step S323_1, the prediction section 33 predicts a remaining time of the optimization problem with reference to the distance calculated by the second calculation section 12.

For example, the prediction section 33 predicts a remaining time of the optimization problem with use of a prediction model which has been generated by machine learning. The prediction model is a model that has learned, while using a distance as input, to output a predicted remaining time of an optimization problem.

Thus, the prediction section 33 predicts a remaining time of the optimization problem with use of the prediction model which has been generated by machine learning. Therefore, the prediction section 33 can suitably predict a remaining time of the optimization problem.

Note that, in step S33 described above, the output section 34 may output, via the communication section 35, the remaining time calculated in step S323_1 in addition to the distance calculated in step S322_1.

### (Example 2 of Process of Calculating Progress Level)

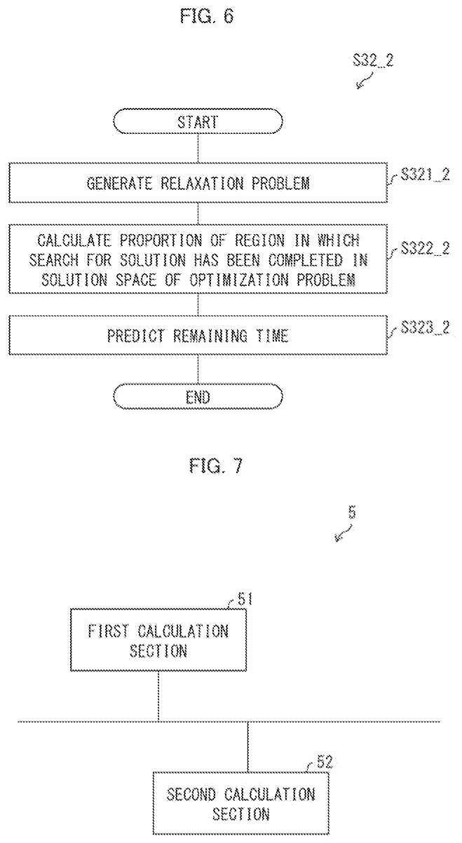

The following description will discuss another example of the process of the foregoing step S32, with reference to FIG. 6. FIG. 6 is a flowchart illustrating a flow of a process S32_2 of calculating a progress level in the present example reference embodiment. With reference to FIG. 6, a process will be described in which the second calculation section 12 calculates, as a progress level, a search rate r that indicates a proportion of a region in which search for a solution has been completed in a solution space of an optimization problem.

### (Step S321_2)

In step S321_2, the generation section 32 generates a relaxation problem in which a variable to be optimized in an optimization problem is a continuous variable. The method in which the generation section 32 generates a relaxation problem is as described above. The generation section 32 causes the storage section 36 to store the generated relaxation problem.

### (Step S322_2)

In step S322_2, the second calculation section 12 calculates, as a progress level, a search rate r that indicates a proportion of a region in which search for a solution has been completed in a solution space of an optimization problem, by referring to an intermediate solution x and a global optimum solution xₒₚₜ or an approximate solution x_{LP}. The following description will discuss step S322_2 in detail. In the following description, the search rate is expressed as a percentage. Specifically, it is assumed that a search rate r in a case in which search in an entire solution space has been completed is 100%, and a search rate r in a case in which search for a solution has not been carried out at all before starting optimization calculation is 0%.

The second calculation section 12 first acquires a relaxation problem from the storage section 36. Then, the second calculation section 12 calculates an optimum solution (i.e., an approximate solution x_{LP} of a global optimum solution xₒₚₜ) of the relaxation problem.

In a case where the second calculation section 12 has been able to acquire a global optimum solution xₒₚₜ from the storage section 36, the second calculation section 12 determines whether or not an intermediate solution X matches the global optimum solution xₒₚₜ. In a case where the intermediate solution x and the global optimum solution xₒₚₜ match, the second calculation section 12 regards that search in the entire solution space has been completed and sets a search rate r to 100%.

Meanwhile, in a case where the intermediate solution x and the global optimum solution xₒₚₜ do not match, the second calculation section 12 calculates a search rate r using the following formula (3).

$$\\ \begin{matrix}r = 100 \times \frac{\vert x - {x}_{LP}^{{}_{} -} \vert}{\vert {x}_{LP} - {x}_{LP}^{{}_{} -} \vert} & ( 3 )\end{matrix}$$

The second calculation section 12 may calculate a search rate r using a learned model. For example, it is possible to employ a configuration in which the second calculation section 12 uses a learned model that uses an intermediate solution x and a global optimum solution xₒₚₜ or an approximate solution x_{LP} as input and that outputs a search rate r between the intermediate solution x and the global optimum solution xₒₚₜ or a search rate r between the intermediate solution x and the approximate solution x_{LP}.

Thus, the second calculation section 12 calculates, as a progress level of optimization calculation, a search rate r that is a proportion of a region in which search for a solution has been completed in a solution space of an optimization problem, by referring to an intermediate solution x and a global optimum solution xₒₚₜ or an approximate solution x_{LP}. Therefore, the second calculation section 12 can provide, as an index necessary for correction of an optimization problem, a proportion of a region in which search for a solution has been completed in a solution space of an optimization problem.

### (Step S323_2)

In step S323_2, the prediction section 33 predicts a remaining time of an optimization problem with reference to the search rate r which has been calculated by the second calculation section 12.

For example, the prediction section 33 predicts a remaining time of an optimization problem with use of the prediction model which has been generated by machine learning. The prediction model is a model that has learned, while using a search rate r as input, to output a predicted remaining time of an optimization problem.

Thus, the prediction section 33 predicts a remaining time of an optimization problem with use of the prediction model which has been generated by machine learning. Therefore, the prediction section 33 can suitably predict a remaining time of an optimization problem.

As another example, the prediction section 33 predicts a remaining time of an optimization problem by input into a rule-based algorithm.

Examples of the rule-based algorithm include an algorithm in which a calculation time until a search rate reaches 100% is predicted using a regression formula which uses a feasible solution xₙ obtained during calculation and a time tₙ taken to obtain an intermediate solution x and in which the calculation time is set to be an objective variable and the search rate is used as an explanatory variable. Examples of the regression formula include t=p×(search rate)+q. The value p+q is a predicted value of a time necessary for completion of all searches.

As such, the prediction section 33 predicts a remaining time of an optimization problem with use of a rule-based algorithm. Therefore, the prediction section 33 can suitably predict a remaining time of an optimization problem.

Note that, in step S33 described above, the output section 34 may output, via the communication section 35, the remaining time calculated in step S323_2 in addition to the search rate r calculated in step S322_2.

### (Example Advantage of Information Processing Apparatus 3)

As such, the information processing apparatus 3 in accordance with the present example reference embodiment generates a relaxation problem in which a variable to be optimized is a continuous variable in an optimization problem, and calculates a progress level (distance or search rate r) while using an optimum solution of the relaxation problem as an approximate solution x_{LP} of a global optimum solution xₒₚₜ. The optimum solution of the relaxation problem can be optimization-calculated higher speed as compared with a problem in which a discrete variable exists. Therefore, the information processing apparatus 3 in accordance with the present example reference embodiment makes it possible to reduce a calculation time.

### First Example Embodiment

The following description will discuss a first example embodiment of the present invention in detail, with reference to the drawings. The present example embodiment is a basic form of example embodiments described later.

### (Configuration of Information Processing Apparatus 5)

The following description will discuss a configuration of an information processing apparatus 5 in accordance with the present example embodiment, with reference to FIG. 7. FIG. 7 is a block diagram illustrating the configuration of the information processing apparatus 5 in accordance with the present example embodiment.

The information processing apparatus 5 in accordance with the present example embodiment is an apparatus that calculates a robustness index of a solution with respect to a constraint condition, the solution being a solution of an optimization problem which has been calculated under the constraint condition that has been set in advance.

The information processing apparatus 5 in accordance with the present example embodiment includes, as illustrated in FIG. 7, a first calculation section 51 and a second calculation section 52. The first calculation section 51 and the second calculation section 52 are configured to realize, in the present example embodiment, the first calculation means and the second calculation means, respectively.

The first calculation section 51 calculates a solution of an optimization problem under a constraint condition that has been set in advance. The first calculation section 51 supplies the calculated solution to the second calculation section 52.

The second calculation section 52 calculates, based on the solution calculated by the first calculation section 51 and the constraint condition, a robustness index of the solution with respect to the constraint condition.

As described above, the information processing apparatus 5 in accordance with the present example embodiment employs the configuration of including: the first calculation section 51 that calculates a solution of an optimization problem under a constraint condition that has been set in advance; and the second calculation section 52 that calculates a robustness index of the solution with respect to the constraint condition based on the solution calculated by the first calculation section 51 and the constraint condition.

A solution of an optimization problem may be infeasible due to a human error, a measurement error, and other uncertain factors in creating the problem. According to the information processing apparatus 5 in accordance with the present example embodiment, a robustness index of a solution is calculated which indicates a degree to which the calculated solution of the optimization problem is affected by a change of a constraint condition. A user can determine, with reference to the robustness index of the solution with respect to the constraint condition, whether or not the optimization problem is correct. Therefore, according to the information processing apparatus 5 in accordance with the present example embodiment, it is possible to provide an index that is necessary for correction of an optimization problem.

### (Flow of Information Processing Method S5)

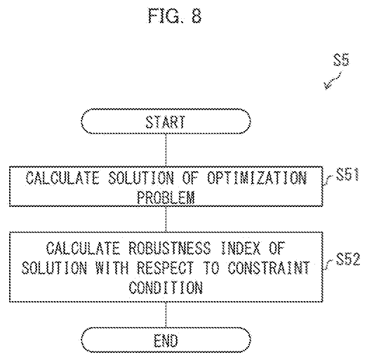

The following description will discuss a flow of an information processing method S5 in accordance with the present example embodiment, with reference to FIG. 8. FIG. 8 is a flowchart illustrating the flow of the information processing method S5 in accordance with the present example embodiment.

### (Step S51)

In step S51, the first calculation section 51 calculates a solution of an optimization problem under a constraint condition that has been set in advance. The first calculation section 51 supplies the calculated solution to the second calculation section 52.

### (Step S52)

In step S52, the second calculation section 52 calculates, based on the solution calculated by the first calculation section 51 and the constraint condition, a robustness index of the solution with respect to the constraint condition.

As described above, the information processing method S5 in accordance with the present example embodiment employs the configuration of including: step S51 in which the first calculation section 51 calculates a solution of an optimization problem under a constraint condition that has been set in advance; and step S52 in which the second calculation section 52 calculates a robustness index of the solution with respect to the constraint condition based on the solution calculated by the first calculation section 51 and the constraint condition. Therefore, according to the information processing method S1 in accordance with the present example embodiment, an example advantage similar to that of the foregoing information processing apparatus 5 is brought about.

### Second Example Embodiment

The following description will discuss a second example embodiment of the present invention in detail, with reference to the drawings. The same reference numerals are given to constituent elements which have functions identical with those described in the first example embodiment, and descriptions as to such constituent elements are omitted as appropriate.

### (Configuration of Information Processing Apparatus 7)

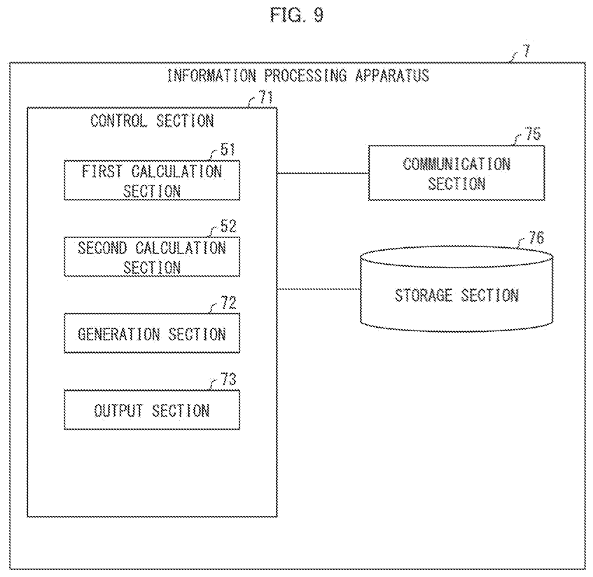

The following description will discuss a configuration of an information processing apparatus 7 in accordance with the present example embodiment, with reference to FIG. 9. FIG. 9 is a block diagram illustrating the configuration of the information processing apparatus 7 in accordance with the present example embodiment.

The information processing apparatus 7 in accordance with the present example embodiment is an apparatus that calculates a robustness index of a solution with respect to a constraint condition, the solution being a solution of an optimization problem which has been calculated under the constraint condition that has been set in advance. The solution of the optimization problem calculated under the constraint condition that has been set in advance may be a local solution or may be a global optimum solution.

The information processing apparatus 7 in accordance with the present example embodiment includes, as illustrated in FIG. 9, a control section 71, a communication section 75, and a storage section 76.

The communication section 75 is an interface that transmits and receives data. Examples of data received by the communication section 75 include a variable to be optimized, an objective function, and a constraint condition. Examples of data transmitted by the communication section 35 include a robustness index of a solution with respect to a constraint condition.

The information processing apparatus 7 may be configured to include, instead of or in addition to the communication section 75, a data input section which is an interface for receiving data input, and a data output section which is an interface for outputting data.

The storage section 76 stores data which the control section 71 refers to. Examples of data stored in the storage section 76 include a variable to be optimized, an objective function, a constraint condition, a solution of an optimization problem, a changed constraint condition (described later), and a robustness index of the solution.

### (Control Section 71)

The control section 71 controls constituent elements included in the information processing apparatus 7. The control section 71 includes a first calculation section 51, a second calculation section 52, a generation section 72, and an output section 73. The first calculation section 51, the second calculation section 52, and the generation section 72 are configured to realize, in the present example embodiment, the first calculation means, the second calculation means, and the generation means, respectively.

The first calculation section 51 calculates a solution of an optimization problem under a constraint condition that has been set in advance. For example, the first calculation section 51 calculates a solution of an optimization problem based on a variable to be optimized, an objective function, and a constraint condition that are stored in the storage section 76. The first calculation section 51 causes the storage section 76 to store the calculated solution.

The second calculation section 52 calculates a robustness index of a solution with respect to a constraint condition. For example, the second calculation section 52 calculates a robustness index of a solution with respect to a constraint condition based on the solution stored in the storage section 76 and a changed constraint condition which has been generated by the generation section 72. For example, the second calculation section 52 calculates, as a robustness index, a proportion of a constraint condition satisfied by a solution calculated by the first calculation section 51 among a plurality of changed constraint conditions which have been generated by the generation section 72. An example of a process in which the second calculation section 52 calculates a robustness index of a solution will be described later.

The generation section 72 generates a changed constraint condition. For example, the generation section 72 generates a changed constraint condition by adding noise to the constraint condition stored in the storage section 76. Moreover, the generation section 72 generates a plurality of changed constraint conditions by repeating the process of adding noise to the constraint condition stored in the storage section 76. An example of a process in which the generation section 72 generates a plurality of changed constraint conditions will be described later.

The output section 73 outputs data via the communication section 75. For example, the output section 73 outputs the robustness index of a solution calculated by the second calculation section 52.

The output section 73 may output a robustness index of a solution (or a robustness index of a solution for each of coefficients included in a constraint condition (described later)) as an image via a display or as audio via a speaker. The output section 73, in the case of output as an image, may sort and output robustness indexes in descending order (or ascending order) of the robustness indexes. The output section 73 may output robustness indexes so that the robustness indexes are displayed in a bar graph or a circle graph.

### (Flow of Information Processing Method S7)

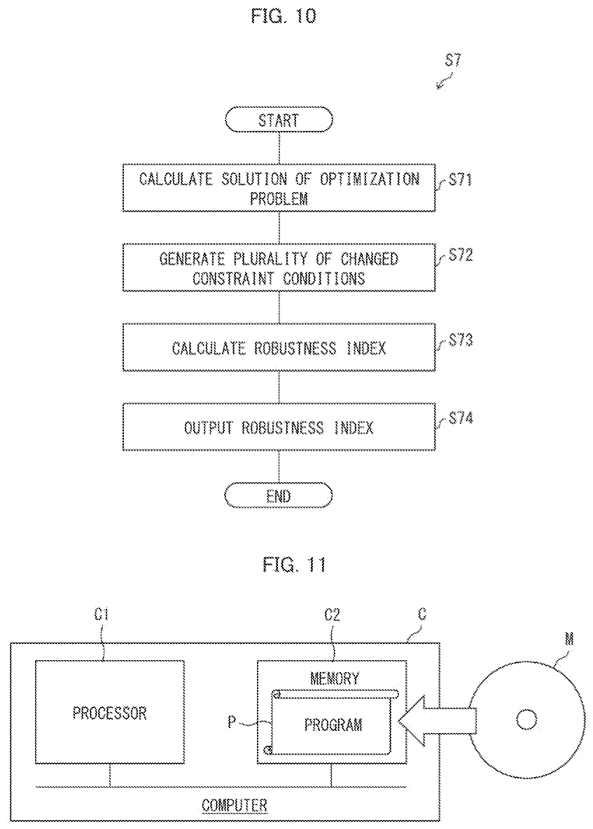

The following description will discuss a flow of a process in which the information processing apparatus 7 outputs a solution accuracy index, with reference to FIG. 10. FIG. 10 is a flowchart illustrating the flow of the information processing method S7 in accordance with the present example embodiment.

### (Step S71)

In step S71, the first calculation section 51 calculates a solution of an optimization problem based on a variable to be optimized, an objective function, and a constraint condition that are stored in the storage section 76. The first calculation section 51 causes the storage section 76 to store the calculated solution.

### (Step S72)

In step S72, the generation section 72 generates a plurality of changed constraint conditions by adding noise to the constraint condition stored in the storage section 76. The generation section 72 causes the storage section 76 to store the plurality of changed constraint conditions which have been generated.

In step S72, the generation section 72 may generate a changed constraint condition by adding a value as noise to at least one coefficient included in the constraint condition stored in the storage section 76. The generation section 72 generates a plurality of changed constraint conditions by changing a coefficient to which a value is to be added or a value to be added. The generation section 72 causes the storage section 76 to store the plurality of changed constraint conditions which have been generated. Thus, the generation section 72 can generate a plurality of changed constraint conditions by repeating the process of adding a value as noise to at least one coefficient included in the constraint condition.

For example, assuming that there is a constraint condition ax₁+bx₂=1, the generation section 72 generates a constraint condition (a+ε)x₁+bx₂=1 in which a value has been added to a coefficient a. Next, the generation section 72 generates a constraint condition ax₁+(b+λ)x₂=1 in which a value has been added to a coefficient b. Furthermore, the generation section 72 generates a constraint condition (a+ε)x₁+(b+λ)x₂=1 which is obtained by adding values to the coefficients a and b.

As another example, the generation section 72 generates a changed constraint condition by adding a value as noise to one of coefficients included in the constraint condition. The generation section 72 generates a plurality of changed constraint conditions by repeating the process of adding noise to each of the coefficients.

For example, assuming that there is a constraint condition ax₁+bx₂=1, the generation section 72 generates a constraint condition (a+ε)x₁+bx₂=1 in which a value has been added to a coefficient a. Next, the generation section 72 changes a value to be added to the coefficient a and generates a constraint condition (a+μ)x₁+bx₂=1. Subsequently, the generation section 72 generates a constraint condition ax₁+(b+λ)x₂=1 by changing a coefficient to which a value is to be added from the coefficient a to a coefficient b. Furthermore, the generation section 72 changes a value to be added to the coefficient b and generates a constraint condition ax₁+(b+τ)x₂=1.

### (Step S73)

In step S73, the second calculation section 52 calculates a robustness index of a solution with respect to a constraint condition based on the solution (the solution calculated by the first calculation section 51) that is stored in the storage section 76 and a changed constraint condition. The second calculation section 52 causes the storage section 76 to store the calculated robustness index.

For example, in a case where there are 100 changed constraint conditions, and 95 constraint conditions satisfied by the solution, the second calculation section 52 sets a robustness index to “95%”.

As another example, the second calculation section 52 calculates, for each coefficient included in the constraint condition, a robustness index of a solution with respect to the constraint condition. For example, the following description assumes a case in which there is a constraint condition ax₁+bx₂=1, and the generation section 72 generates constraint conditions (a+ε)x₁+bx₂=1, (a+μ)x₁+bx₂=1, ax₁+(b+λ)x₂₌₁, and ax₁+(b+τ)x₂=1.

In this case, the second calculation section 52 calculates how many of the constraint conditions (a+ε)x₁+bx₂=1 and (a+μ)x₁+bx₂=1 are satisfied by the solution stored in the storage section 76. For example, in a case where the solution stored in the storage section 76 satisfies only the constraint condition (a+ε)x₁+bx₂=1, the second calculation section 52 sets a robustness index of the coefficient a to “50%”. As another example, in a case where the solution stored in the storage section 76 satisfies both of the constraint conditions (a+ε)x₁+bx₂=1 and (a+μ)x₁+bx₂=1, the second calculation section 52 sets a robustness index of the coefficient a to “100%”. The second calculation section 52 similarly calculates, for the coefficient b, a robustness index of the coefficient b.

Thus, the second calculation section 52 calculates, for each coefficient included in the constraint condition, a robustness index of a solution with respect to the constraint condition. As such, the second calculation section 52 provides a robustness index for each coefficient of a constraint condition. Therefore, it is possible to provide an index that is necessary for correction of an optimization problem.

As yet another example, the second calculation section 52 calculates a robustness index of a solution with respect to a constraint condition using a calculation algorithm which has been generated by machine learning so as to output a robustness index while using, as input, the solution and a plurality of changed constraint conditions generated by the generation section 72. Specifically, the second calculation section 52 inputs the solution stored in the storage section 76 and a plurality of changed constraint conditions into the calculation algorithm. Then, the second calculation section 52 sets, as a robustness index of the solution with respect to the constraint condition, a value output from the calculation algorithm.

As such, the second calculation section 52 calculates a robustness index of a solution with respect to a constraint condition using a calculation algorithm which has been generated by machine learning so as to output a robustness index while using, as input, the solution and a plurality of changed constraint conditions. Therefore, the second calculation section 52 can suitably calculate a robustness index.

### (Step S74)

In step S74, the output section 73 outputs a robustness index that is stored in the storage section 76.

### (Example Advantage of Information Processing Apparatus 7)

As such, the information processing apparatus 7 in accordance with the present example embodiment generates a plurality of changed constraint conditions each of which is obtained by adding noise to the constraint condition, and calculates, as a robustness index of a solution with respect to the constraint condition, a proportion of a constraint condition which is satisfied by the solution among the plurality of changed constraint conditions. Therefore, according to the information processing apparatus 7 in accordance with the present example embodiment also, it is possible to provide an index that is necessary for correction of an optimization problem.

### Example Application

The following description will discuss an example application in which the information processing apparatus 7 is used in arrangement optimization of health professionals such as nurses and doctors. Specifically, an example application in which the information processing apparatus 7 is used to decide work shifts of health professionals will be described with reference to FIG. 12. Note that this example application may be applied to the configuration of the first example embodiment.

FIG. 12 illustrates an example of a table indicating work shifts of health professionals who belong to a certain organization in this example application. Specifically, FIG. 12 illustrates an example of work shifts during a target period (here, one month in June) of all health professionals (including health professionals A through C) belonging to the certain organization. Generation of such work shifts can be formulated as an optimization problem. For example, generation of work shifts can be regarded as a mixed integer programming problem, and any exact solution method can be applied. As another example, generation of work shifts can be regarded as a large-scale discrete optimization problem, and an annealing method can be applied.

In this example application, a flow of deciding work shifts including input by health professionals will be described.

In this example application, each of the health professionals who is a subject of a work shift uses a terminal apparatus to log in to an AI system (work shift management system) implemented by the information processing apparatus 7 and to input a desired work schedule. The AI system then generates optimum work shifts (see FIG. 12) by taking into consideration, as constraint conditions, a desired work schedule or the like input by each of the health professionals (nurses or doctors).

In this configuration, first, the AI system sets, as a decision variable, a work form (e.g., necessity for work) for each health professional for each day. Next, the AI system sets an optimization problem in which affinities, human relationships, and the like among the health professionals are set as constraint conditions, in addition to the above-described desired work schedules or the like. The information processing apparatus 7 in accordance with the present example embodiment then generates work shifts based on a final output solution of the optimization problem. The AI system provides notification to each of the health professionals by displaying the generated work shifts on a terminal apparatus or the like.

Subsequently, each of the health professionals confirms the generated work shifts on a terminal apparatus or the like. In a case where it has been determined that there is no problem in the generated work shift, each of the health professionals uses the terminal apparatus to log in to the AI system and to input approval for the work shift. Meanwhile, in a case where it has been determined that there is a problem in the generated work shift, each of the health professionals uses the terminal apparatus to log in to the AI system and to input a request for correction of the work shift.

Upon detection of input of a request for correction of the work shift, the AI system corrects the optimization problem by, for example, adding a new constraint condition based on the correction request. The addition of a constraint condition or the like may be carried out based on user input by an administrator of the AI system who has confirmed the correction request. Then, the AI system obtains a final output solution of the corrected optimization problem and generates work shifts which the final output solution indicates. In a case where, in this configuration, work shifts which have been approved by all the subject health professionals have been generated, the AI system decides the work shifts as final work shifts.

Thus, by using the information processing apparatus 7 for work shift generation, it is possible to support decision making of an administrator in a medical facility.

### [Software Implementation Example]

Some or all of the functions of each of the information processing apparatuses 1, 3, 5, and 7 may be implemented by hardware such as an integrated circuit (IC chip), or may be implemented by software.

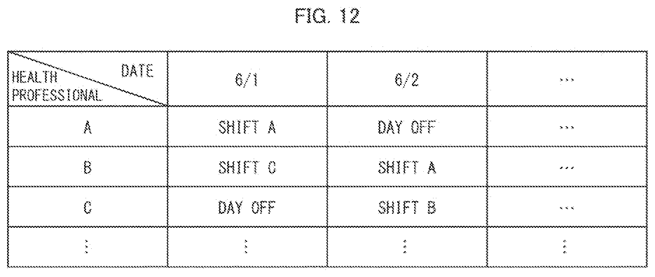

In the latter case, the information processing apparatuses 1, 3, 5, and 7 are implemented by, for example, a computer that executes instructions of a program that is software implementing the foregoing functions. FIG. 11 illustrates an example of such a computer (hereinafter, referred to as “computer C”). The computer C includes at least one processor C1 and at least one memory C2. The memory C2 stores a program P for causing the computer C to operate as the information processing apparatuses 1, 3, 5, and 7. The processor C1 of the computer C retrieves the program P from the memory C2 and executes the program P, so that the functions of the information processing apparatuses 1, 3, 5, and 7 are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface through which data can be transmitted to and received from another apparatus. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### (Supplementary Note 1)

An information processing apparatus including: a first calculation means for calculating a solution of an optimization problem under a constraint condition which has been set in advance; and a second calculation means for calculating a robustness index of the solution with respect to the constraint condition based on the solution and the constraint condition.

### (Supplementary Note 2)

The information processing apparatus according to supplementary note 1, further including: a generation means for generating a plurality of changed constraint conditions each of which is obtained by adding noise to the constraint condition.

### (Supplementary Note 3)

The information processing apparatus according to supplementary note 2, in which: the second calculation means calculates, as the robustness index, a proportion of a constraint condition satisfied by the solution among the plurality of changed constraint conditions which have been generated by the generation means.

### (Supplementary Note 4)

The information processing apparatus according to supplementary note 2 or 3, in which: the generation means generates a changed constraint condition by adding a value as noise to at least one coefficient included in the constraint condition; and the generation means generates a plurality of changed constraint conditions by changing a coefficient to which a value is to be added or by changing a value to be added.

### (Supplementary Note 5)

The information processing apparatus according to supplementary note 2 or 3, in which: the generation means generates a changed constraint condition by adding a value as noise to one of coefficients included in the constraint condition; the generation means generates a plurality of changed constraint conditions by repeating a process of adding noise to each of the coefficients; and the second calculation means calculates the robustness index for each of the coefficients included in the constraint condition.

### (Supplementary Note 6)

The information processing apparatus according to supplementary note 2, in which: the second calculation means calculates the robustness index with use of a calculation algorithm that has been generated by machine learning so as to output the robustness index while using, as input, the solution and the plurality of changed constraint conditions generated by the generation means.

### (Supplementary Note 7)

An information processing method including: calculating, by an information processing apparatus, a solution of an optimization problem under a constraint condition which has been set in advance; and calculating, by the information processing apparatus, a robustness index of the solution with respect to the constraint condition based on the solution and the constraint condition.

### (Supplementary Note 7a)

The information processing method according to supplementary note 7, further including: generating a plurality of changed constraint conditions each of which is obtained by adding noise to the constraint condition.

### (Supplementary Note 7b)

The information processing method according to supplementary note 7a, in which: in the calculating of a robustness index of the solution, a proportion of a constraint condition satisfied by the solution among the plurality of changed constraint conditions which have been generated in the generating is calculated as the robustness index.

### (Supplementary Note 7c)

The information processing method according to supplementary note 7a, in which: in the calculating of a robustness index of the solution, the robustness index is calculated with use of a calculation algorithm that has been generated by machine learning so as to output the robustness index while using, as input, the solution and the plurality of changed constraint conditions generated in the generating.

### (Supplementary Note 8)

A program for causing a computer to function as an information processing apparatus, the program causing the computer to function as: a first calculation means for calculating a solution of an optimization problem under a constraint condition which has been set in advance; and a second calculation means for calculating a robustness index of the solution with respect to the constraint condition based on the solution and the constraint condition.

### (Supplementary Note 8a)

The program according to supplementary note 8, causing the computer to further function as: a generation means for generating a plurality of changed constraint conditions each of which is obtained by adding noise to the constraint condition.

### (Supplementary Note 8b)

The program according to supplementary note 8a, in which: the second calculation means calculates, as the robustness index, a proportion of a constraint condition satisfied by the solution among the plurality of changed constraint conditions which have been generated by the generation means.

### (Supplementary Note 8c)

The program according to supplementary note 8a, in which: the second calculation means calculates the robustness index with use of a calculation algorithm that has been generated by machine learning so as to output the robustness index while using, as input, the solution and the plurality of changed constraint conditions generated by the generation means.

### (Supplementary Note 9)

An information processing apparatus including at least one processor, the at least one processor carrying out: a first calculation process of calculating a solution of an optimization problem under a constraint condition which has been set in advance; and a second calculation process of calculating a robustness index of the solution with respect to the constraint condition based on the solution and the constraint condition.

Note that the information processing apparatus can further include a memory. The memory can store a program for causing the at least one processor to execute the first calculation process and the second calculation process. The program can be stored in a computer-readable non-transitory tangible storage medium.

### REFERENCE SIGNS LIST

1, 3, 5, 7: Information processing apparatus
51: First calculation section
52: Second calculation section
72: Generation section
73: Output section

1. An information processing apparatus comprising at least one processor, the at least one processor carrying out:
a first calculation process of calculating a solution of an optimization problem under a constraint condition which has been set in advance; and
a second calculation process of calculating a robustness index of the solution with respect to the constraint condition based on the solution and the constraint condition.

2. The information processing apparatus according to claim 1, wherein:
the at least one processor further carries out a generation process of generating a plurality of changed constraint conditions each of which is obtained by adding noise to the constraint condition.

3. The information processing apparatus according to claim 2, wherein:
in the second calculation process, the at least one processor calculates, as the robustness index, a proportion of a constraint condition satisfied by the solution among the plurality of changed constraint conditions which have been generated in the generation process.

4. The information processing apparatus according to claim 2, wherein:
in the generation process, the at least one processor generates a changed constraint condition by adding a value as noise to at least one coefficient included in the constraint condition; and
in the generation process, the at least one processor generates a plurality of changed constraint conditions by changing a coefficient to which a value is to be added or by changing a value to be added.

5. The information processing apparatus according to claim 2, wherein:
in the generation process, the at least one processor generates a changed constraint condition by adding a value as noise to one of coefficients included in the constraint condition;
in the generation process, the at least one processor generates a plurality of changed constraint conditions by repeating a process of adding noise to each of the coefficients; and
in the second calculation process, the at least one processor calculates the robustness index for each of the coefficients included in the constraint condition.

6. The information processing apparatus according to claim 2, wherein:
in the second calculation process, the at least one processor calculates the robustness index with use of a calculation algorithm that has been generated by machine learning so as to output the robustness index while using, as input, the solution and the plurality of changed constraint conditions generated in the generation process.

7. An information processing method comprising:
calculating, by at least one processor, a solution of an optimization problem under a constraint condition which has been set in advance; and
calculating, by the at least one processor, a robustness index of the solution with respect to the constraint condition based on the solution and the constraint condition.

8. A computer-readable non-transitory storage medium storing a program for causing a computer to function as an information processing apparatus, the program causing the computer to carry out:
a first calculation process of calculating a solution of an optimization problem under a constraint condition which has been set in advance; and
a second calculation process of calculating a robustness index of the solution with respect to the constraint condition based on the solution and the constraint condition.
